(19) United States
(12) Patent Application Publication
(10) Pub. No.: US 2011/0129673 A1
(43) Pub. Date: Jun. 2, 2011

(54) SILVER-COATED BORON NITRIDE PARTICULATE MATERIALS AND FORMULATIONS CONTAINING SAME

(75) Inventors: Shashi Gupta, Tustin, CA (US); Jie Bai, Aliso Viejo, CA (US); Tadashi Takano, Irvine, CA (US); GuiXiang Yang, Plainville, MA (US)

(73) Assignee: Henkel Corporation

(21) Appl. No.: 12/628,966

(22) Filed: Dec. 1, 2009

(51) Int. Cl. B32B 5/16; C08K 3/38; H01B 1/20

(52) U.S. Cl. 428/403; 523/200; 252/500

(57) ABSTRACT

In accordance with the present invention, there are provided filled epoxy-based formulations wherein the filler comprises silver-coated boron nitride particulate material. In accordance with a further embodiment of the present invention, there are provided articles comprising particulate boron nitride having a silver coating on at least a portion of the surface thereof. In additional embodiments of the present invention, there are provided methods for the use of invention articles and formulations.

### FIELD OF THE INVENTION

The present invention relates to silver-coated boron nitride particulate materials, which are useful, for example, as filler for adhesive formulations. In a particular aspect, the present invention relates to epoxy-based resin formulations filled with silver-coated boron nitride particulate materials.

### BACKGROUND OF THE INVENTION

Since filler materials are used in a wide variety of applications, many different filler materials have been developed and described in the art.

For many engineering adhesive applications, fillers are employed in efforts to achieve acceptable performance of the resulting product with respect to such properties as thermal conductivity, electrical conductivity, physical toughness, and the like. Since such materials are frequently used in substantial quantities, it is desirable that such materials be available in the quantities required, and at reasonable cost. Therefore, the availability of suitable filler materials to facilitate achieving such performance properties, and at reasonable cost, would be of significant interest.

### SUMMARY OF THE INVENTION

In accordance with the present invention, there are provided filled epoxy-based formulations wherein the filler comprises silver-coated boron nitride particulate material.

In accordance with a further embodiment of the present invention, there are provided articles comprising particulate boron nitride having silver coated on at least a portion of the surface thereof.

In additional embodiments of the present invention, there are provided methods for the use of invention articles and formulations.

### DETAILED DESCRIPTION OF THE INVENTION

In accordance with the present invention, there are provided formulations comprising:

an epoxy matrix, and

particulate boron nitride having a silver coating on at least a portion of the surface thereof,

wherein the boron nitride is in the form of a powder or a flake,

wherein the silver coating comprises in the range of about 10 up to 80 weight percent of the silver-coated boron nitride particulate material, and

wherein the particulate boron nitride is dispersed in the epoxy matrix.

In accordance with another embodiment of the present invention, there are provided articles comprising particulate boron nitride having a silver coating on at least a portion of the surface thereof,

wherein the boron nitride is in the form of a powder or a flake,

wherein the silver coating comprises in the range of about 10 up to 80 weight percent of the silver-coated boron nitride particulate material.

Particulate boron nitride contemplated for use in the practice of the present invention can be in the form of a powder or a flake. For example, when the boron nitride is in the form of a powder, it will typically have a mean particle size in the range of about 0.5 up to about 10 μm, and a surface area in the range of about 1-10 m²/g. Presently preferred boron nitride powders have a mean particle size of about 9 μm, and a surface area of about 3 m²/g.

Alternatively, when the boron nitride is in the form of a flake, it will typically have a mean particle size in the range of about 0.5 up to about 10 μm, and a surface area in the range of about 10-20 m²/g. Presently preferred boron nitride flakes have a mean particle size of about 9 μm, and a surface area of about 15 m²/g.

In accordance with the present invention, a silver coating is applied to at least a portion of the surface of the boron nitride particulate material. Typically, sufficient silver coating is applied to the boron nitride particulate so as to comprise in the range of about 10 up to about 80 weight percent of the final particle weight (i.e., of the silver-coated boron nitride particulate material); preferably the silver coating comprises in the range of about 20 up to about 70 weight percent of the final particle weight; and it is presently preferred that the silver coating comprise in the range of about 30 up to about 60 weight percent of the final particle weight.

Typically, the thickness of the silver coating falls in the range of about 1 up to about 10 nm, with an average thickness of the silver coating of about 5 nm being presently preferred.

While the silver coating is contemplated to cover at least a portion of the surface of the boron nitride particulate material, it is presently preferred that the silver coating substantially completely cover the surface of the particulate boron nitride. It is also presently preferred that the silver coating be substantially uniformly applied to the boron nitride particulate material.

A particular benefit of the silver-coated boron nitride particulate material of the present invention is the fact that these materials are both electrically and thermally conductive, and impart such properties to numerous formulations prepared employing same.

For example, in accordance with one aspect of the present invention, the silver-coated particulate boron nitride materials described herein are dispersed in an epoxy matrix. It has been observed that the silver-coated boron nitride materials, upon distribution in the epoxy matrix, remain electrically and thermally conductive.

When the invention silver-coated boron nitride particulate material is dispersed in an epoxy matrix, the silver-coated boron nitride material typically comprises in the range of about 40 up to about 80 wt % of the formulation. In certain embodiments of the present invention, the silver-coated boron nitride material comprises in the range of about 50 up to about 60 wt % of the formulation.

The epoxy matrix of the present invention may be prepared from any common epoxy resin, which may include at least one multifunctional epoxy resin.

Examples of such epoxy resins include C4-C28 alkyl glycidyl ethers, C2-C28 alkyl- and alkenyl-glycidyl esters; C1-C28 alkyl-, mono- and poly-phenol glycidyl ethers; polyglycidyl ethers of pyrocatechol, resorcinol, hydroquinone, 4,4′-dihydroxydiphenyl methane (or bisphenol F, such as RE-404-S or RE-410-S available commercially from Nippon Kayaku, Japan), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4″-dihydroxy-3,3′-dimethyldiphenyl propane, 4,4′-dihydroxydiphenyl sulfone, and tris(4-hydroxyphenyl)methane; polyglycidyl ethers of transition metal complex chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations of any two or more thereof.

Among the commercially available epoxy resins suitable for use herein are polyglycidyl derivatives of phenolic compounds, such as those available under the tradenames EPON 828, EPON 1001, EPON 1009, and EPON 1031, from Shell Chemical Co.; DER 331, DER 332, DER 334, and DER 542 from Dow Chemical Co.; GY285 from Ciba Specialty Chemicals, Tarrytown, N.Y.; and BREN-S from Nippon Kayaku, Japan. Other suitable epoxy resins include polyepoxides prepared from polyols and the like and polyglycidyl derivatives of phenol-formaldehyde novolacs, the latter of which are available commercially under the tradenames DEN 431, DEN 438, and DEN 439 from Dow Chemical Company. Cresol analogs are also available commercially ECN 1235, ECN 1273, and ECN 1299 from Ciba Specialty Chemicals. SU-8 is a bisphenol A-type epoxy novolac available from Shell Chemicals (formerly, Interez, Inc.). Polyglycidyl adducts of amines, aminoalcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE MY-721, ARALDITE 0500, and ARALDITE 0510 from Ciba Specialty Chemicals and PGA-X and PGA-C from the Sherwin-Williams Co. And of course combinations of the different epoxy resins are also desirable for use herein.

As noted above, the epoxy resin component of the present invention may include any common epoxy resin, at least a portion of which is a multifunctional epoxy resin. Typically, the multifunctional epoxy resin is included in an amount within the range of about 20 weight percent to about 100 weight percent of the epoxy resin component.

A monofunctional epoxy resin, if present, should ordinarily be used as a reactive diluent, or crosslink density modifier. In the event such a monofunctional epoxy resin is included as a portion of the epoxy resin component, such resin is typically employed in an amount of up to about 20 weight percent, based on the total epoxy resin component.

In choosing epoxy resins for the epoxy matrix of the invention formulation, consideration should also be given to viscosity and other properties thereof.

As employed herein, “alkyl” refers to hydrocarbyl radicals having 1 up to about 20 carbon atoms, preferably 2-10 carbon atoms; and “substituted alkyl” comprises alkyl groups further bearing one or more substituents selected from alkoxy, cycloalkyl, substituted cycloalkyl, heterocyclic, substituted heterocyclic, aryl, substituted aryl, heteroaryl, substituted heteroaryl, aryloxy, substituted aryloxy, halogen, cyano, nitro, amido, C(O)H, acyl, oxyacyl, carboxyl, carbamate, sulfonyl, sulfonamide, sulfuryl, and the like.

As employed herein, “cycloalkyl” refers to cyclic ring-containing groups containing in the range of 3 up to about 8 carbon atoms, and “substituted cycloalkyl” refers to cycloalkyl groups further bearing one or more substituents as set forth above.

As employed herein, “aryl” refers to aromatic groups having in the range of 6 up to about 14 carbon atoms and “substituted aryl” refers to aryl groups further bearing one or more substituents as set forth above.

As employed herein, “alkylene” refers to divalent hydrocarbyl radicals having 1 up to about 20 carbon atoms, preferably 2-10 carbon atoms; and “substituted alkylene” comprises alkylene groups further bearing one or more substituents as set forth above.

As employed herein, “oxyalkylene” refers to the moiety —O-alkylene-, wherein alkylene is as defined above, and “substituted oxyalkylene” refers to oxyalkylene groups further bearing one or more substituents as set forth above.

As employed herein, “heterocyclic” refers to cyclic (i.e. ring containing) groups containing one or more heteroatoms (e.g. N, O, S, or the like) as part of the ring structure, and having in the range of 3 up to 20 carbon atoms, and “substituted heterocyclic” refers to heterocyclic groups further bearing one or more substituents as set forth above.

Optionally, invention formulations may contain one or more curing agents, i.e., polymerization promoters, co-curing agents, catalysts, initiators or other additives designed to participate in or promote curing of the epoxy-based formulation. With respect to epoxide-based adhesive formulations, such curing agents include polymerization promoters and catalysts such as, for example, anhydrides, amines, imidazoles, amides, thiols, carboxylic acids, phenols, dicyandiamide, urea, hydrazine, hydrazide, amino-formaldehyde resins, melamine-formaldehyde resins, amine-boron trihalide complexes, quaternary ammonium salts, quaternary phosphonium salts, tri-aryl sulfonium salts, di-aryl iodonium salts, diazonium salts, and the like, as well as combinations of any two or more thereof, optionally also including a transition metal complex. Presently preferred curing agents and catalysts for epoxide-based formulations include anhydrides, amines, imidazoles, and the like.

Transition metal complexes contemplated for use herein may be chosen from a variety of organometallic materials or metallocenes as can be readily identified by those of skill in the art.

As readily recognized by those of skill in the art, curing agents contemplated for use in the practice of the present invention will vary with the reactive functionality(ies) present, the presence of optional co-reactant(s), and the like. Typically, the quantity of curing agent, when present, will fall in the range of about 1 weight % up to about 50 weight % of the total composition, with presently preferred amounts of curing agent falling in the range of about 5 weight % up to about 40 weight % of the total composition.

Optionally, invention formulations may also comprise one or more initiators. Exemplary initiators contemplated for use with epoxide-based adhesive formulations include hydroxy functionalized compounds such as, for example, alkylene glycols. Preferred alkylene glycols include ethylene glycols and propylene glycols.

Additional fillers contemplated for optional use in the practice of the present invention, in addition to the silver-coated boron nitride particulate material(s) described herein, may optionally be conductive (electrically and/or thermally). Electrically conductive fillers contemplated for optional use in the practice of the present invention include, for example, silver, nickel, gold, cobalt, copper, aluminum, graphite, silver-coated graphite, nickel-coated graphite, alloys of such metals, and the like, as well as mixtures thereof. Both powder and flake forms of such optional additional filler materials may be used in invention formulations. Preferably, the flake has a thickness of less than about 2 microns, with planar dimensions of about 20 to about 25 microns. Flake employed herein preferably has a surface area of about 0.15 to 5.0 m²/g and a tap density of about 0.4 up to about 5.5 g/cc. It is presently preferred that powder employed in the practice of the invention has a diameter of about 0.5 to 15 microns. If present, the optional additional filler referred to herein typically comprises in the range of about 20% up to about 50% by weight of the adhesive formulation.

Thermally conductive fillers contemplated for optional use in the practice of the present invention include, for example, aluminum nitride, boron nitride, silicon carbide, diamond, graphite, beryllium oxide, magnesia, silica, alumina, and the like. Preferably, the particle size of these fillers will be about 20 microns. If aluminum nitride is used as a filler, it is preferred that it be passivated via an adherent, conformal coating (e.g., silica, titania, silver, or the like).

Electrically and/or thermally conductive fillers are optionally (and preferably) rendered substantially free of catalytically active metal ions by treatment with chelating agents, reducing agents, nonionic lubricating agents, or mixtures of such agents. Such treatment is described in U.S. Pat. No. 5,447,988, which is incorporated by reference herein in its entirety.

Optional additional fillers contemplated for use herein may be fillers that are neither electrical nor thermal conductors. Such fillers may be desirable to impart some other property to the adhesive formulation such as, for example, reduced thermal expansion of the cured adhesive, reduced dielectric constant, improved toughness, increased hydrophobicity, and the like. Examples of such fillers include perfluorinated hydrocarbon polymers (i.e., TEFLON™), thermoplastic polymers, thermoplastic elastomers, mica, fumed silica, fused silica, glass powder, and the like.

In accordance with another embodiment of the present invention, there are provided methods for adhesively attaching a device to a substrate, such methods comprising dispensing an invention adhesive formulation onto a substrate and/or a device or between the substrate and the device to form an assembly, and exposing the assembly to conditions sufficient to cure the adhesive.

Conditions suitable to cure invention adhesive formulations comprise subjecting invention adhesive formulations to a temperature of at least about 120° C. but less than about 190° C. for about 0.5 up to about 60 minutes. This rapid, short duration heating can be accomplished in a variety of ways, e.g., with an in-line heated rail, a belt furnace, a curing oven, or the like.

In accordance with yet another embodiment of the present invention, there are provided assemblies produced by the above-described methods.

In accordance with a further embodiment of the present invention, there are provided methods for adhesively attaching a first article to a second article, such methods comprising:
(a) applying an invention formulation to the first article,
(b) bringing the first and second article into intimate contact to form an assembly wherein the first article and the second article are separated only by the adhesive composition applied in step (a), and thereafter,
(c) subjecting the assembly to conditions suitable to cure the adhesive formulation.

In accordance with yet another embodiment of the present invention, there are provided assemblies produced by the above-described methods.

In accordance with a still further embodiment of the present invention, there are provided articles comprising an electronic component adhesively attached to a circuit board, wherein the electronic component is adhesively attached to the board by a cured aliquot of invention formulation.

In accordance with still another embodiment of the present invention, there are provided articles comprising an electronic component adhesively attached to a circuit board, wherein the electronic component is adhesively attached to the board by a cured aliquot of invention formulation.

Those of skill in the art recognize that many different electronic packages would benefit from preparation using the invention formulations described herein. Examples of such packages include ball grid arrays, super ball grid arrays, IC memory cards, chip carriers, hybrid circuits, chip-on-hoard, multi-chip modules, pin grid arrays, CSPs, and the like.

The invention will now be described in greater detail by reference to the following non-limiting examples.

### EXAMPLES

### Example 1

### Preparation of Silver-Coated Boron Nitride

A variety of boron nitride materials are commercially available. The following exemplary boron nitride materials were employed herein (used as obtained from PolarTherm):

PolarTherm 120—surface area 3.27-4.35 m²/g; mean particle size 9.2-9.57 μm powder;

PolarTherm 131—surface area 14.82 m²/g; mean particle size 8.5 μm flake;

PolarTherm 140—surface area 5.53 m²/g; mean particle size 9.9 μm flake; and

PolarTherm AC6059—surface area 7.28 m²/g; mean particle size 6.83 μm flake.

A substantially uniform silver coating is applied, at loading levels between about 19 and 76% by weight, to each of the boron nitride materials identified above by mixing boron nitride powder or flakes with a sufficient quantity of a silver metal ion precursor (e.g., a silver plating solution) to achieve the desired coating thickness. Reducing agents such as dextrose, hydrazine, formic acid, and the like, can be used to reduce the silver metal ion in the solution and cause it to precipitate to form a substantially uniform layer of the coating onto the boron nitride powder/flakes. The pH for such coating is typically in the range of about 7-14, and the temperature is typically maintained in the range of about 10-99° C. Suitable base (e.g., sodium hydroxide, potassium hydroxide, or the like) can be added to adequately raise the pH so as to raise the reducing potential of the added reducing agent(s).

The loading of silver to achieve a desired thickness of the silver coating will vary as a function of the surface area of the boron nitride particulate material being treated. Thus, it can be determined that:
about 21% by weight loading of silver is required to provide a 5 nm thick silver film on PolarTherm 120;
about 76% by weight loading of silver is required to provide a 5 nm thick silver film on PolarTherm 131.
   Thus, it can be seen that the amount of silver coating required to achieve a substantially uniform coating on the boron nitride particulate material varies significantly depending on the size, shape and form of the boron nitride particulate (e.g., the higher surface area PolarTherm 131 requires substantially higher silver loading to achieve a comparable thickness of the resulting silver film).

### Example 2

### Conductivity Testing

The conductivity of several formulations prepared as described in Example 1 was determined after being subjected to various temperatures for 24 or 96 hours. Results are summarized in the following tables:

TABLE 1
Conductivity at 24 hr

| Boron | Silver coating, | Temperature, | Conductivity, |
|---|---|---|---|
| Nitride | wt % | ° C. | us/cm |
| PTC120 | 51 | 100 | 53 |
| PTC140 | 45 | 100 | 62 |
| AC6059 | 53 | 100 | 47 |
| PTC120 | 51 | 121 | 110 |
| PTC140 | 45 | 121 | 132 |
| AC6059 | 53 | 121 | 151 |
| PTC120 | 51 | 135 | 164 |
| PTC140 | 45 | 135 | 213 |
| AC6059 | 53 | 135 | 285 |

TABLE 2
Conductivity at 96 hr

| Boron | Silver coating, | Temperature, | Conductivity, |
|---|---|---|---|
| Nitride | wt % | ° C. | us/cm |
| PTC120 | 51 | 100 | 71 |
| PTC140 | 45 | 100 | 102 |
| AC6059 | 53 | 100 | 103 |
| PTC120 | 51 | 121 | 228 |
| PTC140 | 45 | 121 | 351 |
| AC6059 | 53 | 121 | 371 |
| PTC120 | 51 | 135 | 361 |

Review of the data in Tables 1 and 2 indicates that silver-coated boron nitride particulate material having a range of silver loadings, particle sizes, and having been subjected to a variety of storage conditions all provide particulate material with excellent conductivity properties.

### Example 3

### Preparation of Prototype Silver-Coated Boron Nitride-Filled Epoxy Formulations

A suitable quantity of silver-coated boron nitride flakes, and a suitable quantity of an epoxy matrix-forming material, plus curing agent, are combined and cured at 150° C. for one hour.

For example, 59.5% by weight of silver-coated boron nitride flakes, and 40.5% EPON 815, plus curing agent, are combined and cured at 150° C. for one hour.

While the exemplary embodiments described herein are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

What is claimed is:

1. A formulation comprising:
an epoxy matrix, and
particulate boron nitride having a silver coating on at least a portion of the surface thereof,
wherein the boron nitride is in the form of a powder or a flake,
wherein the silver coating comprises in the range of about 10 up to 80 weight percent of the silver-coated boron nitride particulate material, and
wherein the particulate boron nitride is dispersed in the epoxy matrix.

2. The formulation of claim 1, wherein the thickness of the silver coating falls in the range of about 1 up to about 10 nm.

3. The formulation of claim 1, wherein the average thickness of the silver coating is about 5 nm.

4. The formulation of claim 1, wherein the silver coating substantially completely covers the surface of the particulate boron nitride.

5. The formulation of claim 1, wherein the silver coating is substantially uniform.

6. The formulation of claim 1, wherein the boron nitride is a powder having a mean particle size in the range of about 0.5 up to about 10 μm, and a surface area in the range of about 1-10 m²/g.

7. The formulation of claim 6, wherein the mean particle size of the boron nitride is about 9 μm, and the surface area of the boron nitride is about 3 m²/g.

8. The formulation of claim 1, wherein the boron nitride is a flake having a mean particle size in the range of about 0.5 up to about 10 μm, and a surface area in the range of about 10-20 m²/g.

9. The formulation of claim 8, wherein the mean particle size of the boron nitride is about 9 μm, and the surface area of the boron nitride is about 15 m²/g.

10. The formulation of claim 1, wherein the silver-coated boron nitride is electrically and thermally conductive.

11. The formulation of claim 1, wherein the silver-coated boron nitride, upon distribution in the epoxy matrix, remains electrically and thermally conductive.

12. The formulation of claim 1, wherein the silver-coated boron nitride comprises in the range of about 40 up to about 80 wt % of the formulation.

13. The formulation of claim 12, wherein the silver-coated boron nitride comprises in the range of about 50 up to about 60 wt % of the formulation.

14. An article comprising particulate boron nitride having a silver coating on at least a portion of the surface thereof,
wherein the boron nitride is in the form of a powder or a flake,
wherein the silver coating comprises in the range of about 10 up to 80 weight percent of the silver-coated boron nitride particulate material.

15. The article of claim 14, wherein the thickness of the silver coating falls in the range of about 1 up to about 10 nm.

16. The article of claim 14, wherein the average thickness of the silver coating is about 5 nm.

17. The article of claim 14, wherein the silver coating substantially completely covers the surface of the particulate boron nitride.

18. The article of claim 14, wherein the silver coating is substantially uniform.

19. The article of claim 14, wherein the boron nitride is a powder having a mean particle size in the range of about 0.5 up to about 10 μm, and a surface area in the range of about 1-10 m²/g.

20. The article of claim 19, wherein the mean particle size of the boron nitride is about 9 μm, and the surface area of the boron nitride is about 3 m²/g.

21. The article of claim 14, wherein the boron nitride is a flake having a mean particle size in the range of about 0.5 up to about 10 μm, and a surface area in the range of about 10-20 m²/g.

22. The article of claim 21, wherein the mean particle size of the boron nitride is about 9 μm, and the surface area of the boron nitride is about 15 m²/g.

23. The article of claim 14, wherein the article is electrically and thermally conductive.
